(19) United States
(12) Patent Application Publication
(10) Pub. No.: US 2010/0091792 A1
(43) Pub. Date: Apr. 15, 2010

(54) CONVERSION APPARATUS

(75) Inventors: Hiroyuki SASAKI, Kawasaki (JP); Masayuki SATO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/576,613

(22) Filed: Oct. 9, 2009

(30) Foreign Application Priority Data
Oct. 15, 2008 (JP) 2008-266376

(51) Int. Cl. H04J 3/22

(52) U.S. Cl. 370/466

(57) ABSTRACT

A conversion apparatus, which mutually connects a layer 2 network and an asynchronous network, including a first converter that converts a check frame received from the layer 2 network into a check cell of the asynchronous network to transmit the check cell to the asynchronous network; and a second converter that converts the check cell received from the asynchronous network into the check frame of the layer 2 network to transmit the check frame to the layer 2 network.

### CROSS-REFERENCE TO RELATED APPLICATIONS

This application is based upon and claims the benefit of priority of the prior Japanese Patent Application No. 2008-266376, filed on Oct. 15, 2008, the entire contents of which are incorporated herein by reference.

### BACKGROUND

1. Field

The embodiments discussed herein are related to a conversion apparatus which is connected to a layer 2 network and an asynchronous network and performs mutual conversion between a frame of the layer 2 network and a cell of the asynchronous network.

2. Description of the Related Art

Recently, a wide-area Ethernet (Ethernet is a registered trademark) service has attracted attention as a network service by a carrier called WAN (Wide Area Network). Network service using ATM (Asynchronous Transfer Mode) however, is still in use. In this specification, WAN and MAN (Metropolitan Area Network) are included in LAN (Local Area Network).

Therefore, there is a case in which both services are mutually connected, and both networks are used, and a conversion apparatus (hereinafter referred to as an EA converter) is required which performs mutual conversion between a LAN frame and an ATM cell. AAL5 (ATM Adaptation Layer 5), for example, is used as a conversion system.

As the related art, there is Japanese Patent Application Laid-Open No. 2000-261484.

Here, especially when the LAN is an L2 network in which low-cost L2 (Layer 2) switching is performed, in the occurrence of an error, a device error often occurs due to a broadcast storm attributable to confluence of VLAN (Virtual LAN network), the occurrence of a silent failure, and the occurrence of a loop.

Therefore, as an OAM (Operation Administration and Maintenance) function of operation and maintenance of a network apparatus, Ethernet OAM (under discussion in IEEE802.1ag, standardized as Y.1731 in ITU-T, and hereinafter referred to as “EtherOAM”) is required. In a carrier service, an interruption time is increased in the detection of errors based on an end user's report, and therefore, the carrier service emphasizes the error detection, whereby EtherOAM is standardized.

Meanwhile, in ATM, there is no multipoint part which performs flooding, and therefore, there is a system (ITUI.610) in which OAM is exchanged by a method easier than LAN.

### SUMMARY

According to an aspect of the invention, a conversion apparatus which mutually connects a layer 2 network and an asynchronous network includes a first converter that converts a check frame received from the layer 2 network into a check cell of the asynchronous network to transmit the check cell to the asynchronous network; and a second converter that converts the check cell received from the asynchronous network into the check frame of the layer 2 network to transmit the check frame to the layer 2 network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 is a configuration diagram of an example of a conventional network connecting system;

FIG. 2 is a configuration diagram of an embodiment of a network connecting system; FIG. 3 is a configuration diagram of a first embodiment of an EA converter;

FIG. 4 is a view showing an example of a format of a LAN frame;

FIG. 5 is a view for explaining conversion between the LAN frame and an ATM cell;

FIG. 6 is a view showing an example of a format of a CC frame;

FIG. 7 is a view showing an example of the format of the CC frame;

FIG. 8 is a view showing an example of a format of an OAM cell;

FIG. 9 is a flow chart of an OAM frame transmission processing performed by the EA converter;

FIG. 10 is a flow chart of a monitoring processing performed by an OAM processing part;

FIG. 11 is a configuration diagram of a second embodiment of the EA converter;

FIG. 12 is a configuration diagram of a third embodiment of the EA converter; and

FIG. 13 is a view for explaining when a node device of LAN is a multipoint switch.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

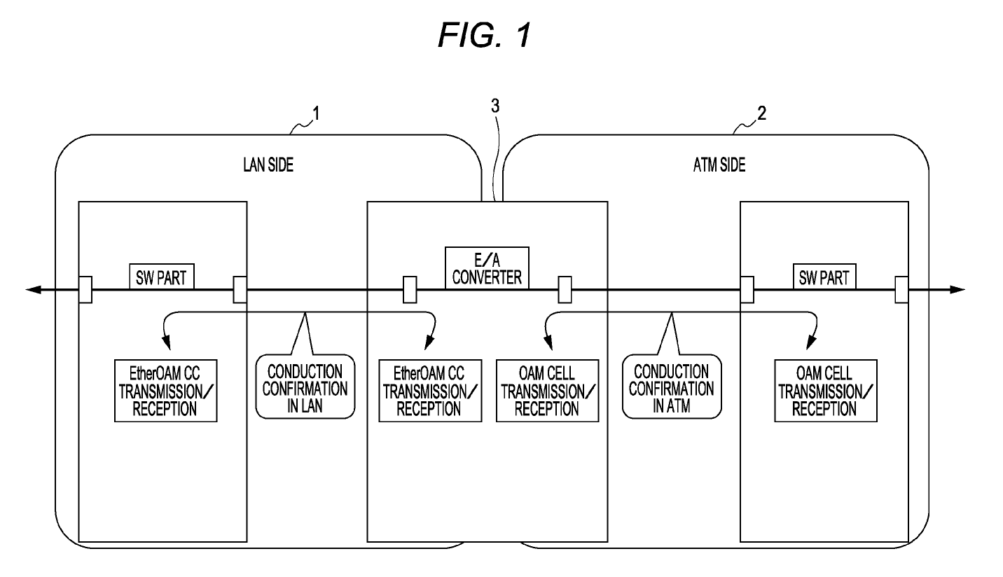

EtherOAM and OAM in ATM have different systems. Therefore, as shown in FIG. 1, in a network in which a LAN 1 and an ATM network 2 are mutually connected through an EA converter 3, conduction is confirmed on the LAN 1 side in EtherOAM, while conduction is confirmed on the ATM network 2 side in OAM in ATM. Consequently there is a problem that conduction cannot be confirmed across the LAN 1 and the ATM network 2.

Hereinafter, embodiments will be described based on the drawings.

<Network Connecting System>

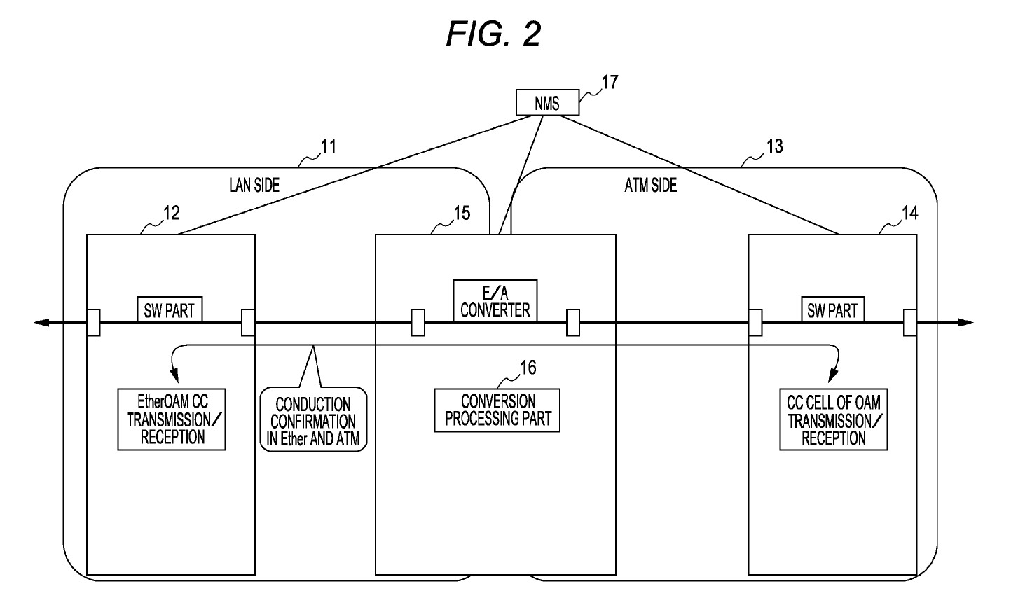

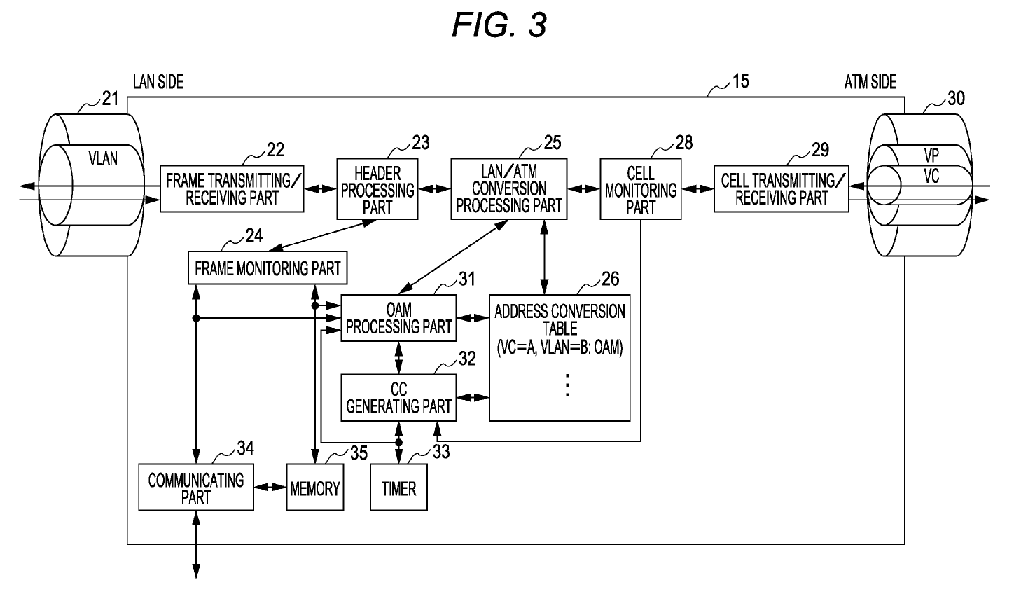

FIG. 2 is a configuration diagram of one embodiment of a network connecting system. A LAN (layer 2 network) 11, which is the L2 network, and an ATM network (asynchronous network) 13 are mutually connected through an EA converter 15. Each node device 12 constituting the LAN 11, each node device 14 constituting the ATM network 13, and the EA converter 15 are connected to an NMS (Network Management System) 17 which manages networks.

In OAM in ATM or EtherOAM, a cell or a frame is transmitted and received for a predetermined period (for example, 1 sec.), and a CC (Continuity Check) is performed. When the cell or the frame cannot be received beyond a predetermined time period (for example, several seconds), it is regarded that a failure has occurred between a transmitter and a receiver.

The EA converter 15 of this embodiment converts CC (hereinafter referred as a “CC frame”) of an EtherOAM frame into CC (hereinafter referred as a “CC cell”) of an OAM cell. The EA converter 15 comprises a conversion processing part 16 which converts the CC cell of ATM into the CC frame of EtherOAM, whereby a non-monitored section is prevented from existing in an EtherOAM network and an OAM network of ATM.

Namely, in the node device 12 on the normal LAN 11 side, conduction can be confirmed by transmitting and receiving the CC frame of EtherOAM. The CC frame is distinguished from an end user frame in the LAN 11; however, when the CC frame of EtherOAM is converted into a normal ATM cell in the EA converter 15, the CC frame is not considered the CC cell of ATM in the ATM network 13.

Thus, the EA converter 15 has a function of, when the CC frame of EtherOAM arrives at the EA converter 15, converting the CC frame into the CC cell of ATM to transmit the CC cell to the ATM network 13. Further, the EA converter 15 has a function of, when the CC cell from the ATM network 13 arrives at the EA converter 15, transmitting the CC frame of EtherOAM from the CC cell.

The frame or the cell to be transmitted is set by a maintenance person, and the conversion processing is performed in the EA converter 15. The CC cell of ATM is not transmitted during the transmission of the cell of user data, and therefore, when the cell of the user data arrives at the EA converter 15 for a fixed time, even if the CC cell of ATM does not arrive at the EA converter 15, the EA converter 15 automatically generates the CC frame of EtherOAM at the transmission period of EtherOAM and transmits the CC frame to the address in the LAN 11.

On the contrary, even if the CC frame of Ether OAM arrives at the EA converter 15, when a user in the LAN 11 transmits the cell of the user data to the address in the ATM network 13, the EA converter 15 does not transmit the CC cell of ATM to the address in the ATM network 13.

The above operation is performed in the EA converter 15, whereby even if EtherOAM and OAM of ATM are different in specification, conduction can be confirmed between the node device 12 in the LAN 11 and the node device 14 in the ATM network 13.

<First Embodiment of EA Converter>

FIG. 3 is a configuration diagram of a first embodiment of the EA converter. A physical port 21 of FIG. 3 is connected to the node device 12 in the LAN 11 of FIG. 2. A frame transmitting/receiving part 22 of FIG. 3 transmits and receives a LAN frame to and from the node device 12 in the LAN 11 of FIG. 2. The LAN frame received by the frame transmitting/receiving part 22 is supplied to a header processing part 23.

<Transmission from LAN to the Direction of ATM Network>

The header processing part 23 extracts tag, type, and Class of Service (CoS) from the LAN frame to supply them to a frame monitoring part 24. According to the supply from the header processing part 23, the frame monitoring part 24 supplies the monitoring information to the header processing part 23. The header processing part 23 supplies the monitoring information to a LAN/ATM conversion part 25 along with the LAN frame from the frame transmitting/receiving part 22.

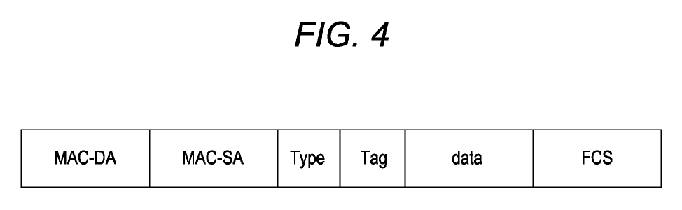

FIG. 4 shows an example of a format of the LAN frame. The LAN frame includes a destination address (MAC-DA), a source address (MAC-SA), a type (Type), a tag (Tag), a data part (data or Payload), and FCS (Flame Check Sequence).

A VLAN tag (VLAN-ID: virtual network identifier) as an address is set to the tag. The Class of service (CoS: the value is any one of 0 to 7, and 7 represents highest priority) as priority information is set in the data part.

In FIG. 3, the frame monitoring part 24 determines, from the type, whether or not the LAN frame is the CC frame of EtherOAM. If the LAN frame is the CC frame, the values of the CC frame, the VLAN-ID, and the Class of Service as the monitoring information are supplied to the LAN/ATM conversion part 25.

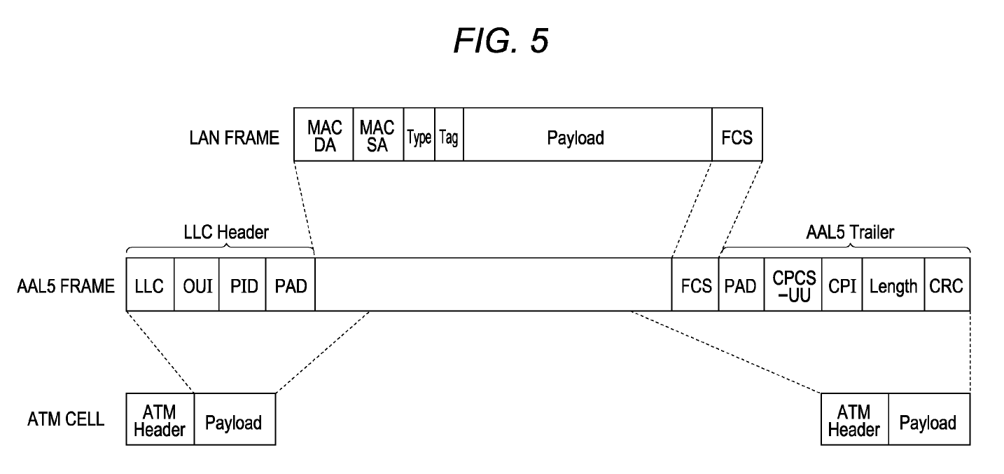

When the LAN frame is not the CC frame of EtherOAM, the LAN/ATM conversion part 25, as shown in FIG. 5, maps the LAN frame to the AAL5 frame and divides the AAL5 frame into a plurality of ATM cells with a fixed length.

In FIG. 5, the AAL5 frame has a constitution in which an LLC header and an AAL5 trailer are added to the LAN frame. The LLC header includes LLC (Logical Link Control), OUI (Organizationally Unique Identifier), and PID (Protocol Identifier). The AAL5 trailer includes PAD (Padding), CPCS-UU (Common Part Convergence Sublayer User-to-User indication), CPI (Common Part Indicator), Length, and CRC (Cyclic Redundancy Check).

In FIG. 3, the LAN/ATM conversion part 25 refers an address conversion table 26 by using the VLAN-ID as the monitoring information supplied from the frame monitoring part 24 and obtains a VC (Virtual Channel) or a VP (Virtual Path).

The value of the VC or the VP, which shows an address in the ATM network corresponding to the VLAN-ID showing the address in the LAN 11, and information showing whether or not conversion between an OAM frame and an OAM cell is required are previously registered on the address conversion table 26.

The LAN/ATM conversion part 25 sets the VC or the VP obtained from the address conversion table 26 to each ATM header of the divisional ATM cells shown in FIG. 5. Each ATM cell from the LAN/ATM conversion part 25 passes through a cell monitoring part 28 and a cell transmitting/receiving part 29 to be transmitted from the physical port 30, corresponding to the VC or the VP of the ATM header, to the node device 14 in the ATM network 13.

Meanwhile, when the LAN frame is the CC frame of EtherOAM, the LAN/ATM conversion part 25 gives the CC frame to the OAM processing part 31 along with the monitoring information.

The OAM processing part 31 converts the CC frame into the CC cell to refer the address conversion table 26 by using the VLAN-ID supplied as the monitoring information, and, thus, to obtain the VC or the VP, whereby the VC or the VP are set to the ATM header of the CC cell. If a cell transmission elapsed time timed by a timer 33 is within the CC period (for example, 1 sec.), the OAM processing part 31 gives the CC cell to the LAN/ATM conversion part 25 once the cell transmission elapsed time is the CC period and resets the cell transmission elapsed time.

The CC cell of ATM from the LAN/ATM conversion part 25 passes through the cell monitoring part 28 and the cell transmitting/receiving part 29 to be transmitted from the physical port 30, corresponding to the VC or the VP of the ATM header, to the node device 14 in the ATM network 13.

The timer 33 times a CC frame received elapsed time from reception of the CC frame for each VLAN-ID and times a cell received elapsed time from reception of the CC cell or a normal cell of the user data for each VC or VP. Further, the timer 33 times a CC frame transmitted elapsed time from transmission of the CC frame for each VLAN-ID and times a cell transmitted elapsed time from transmission of the CC cell or the normal cell of the user data for each VC or VP.

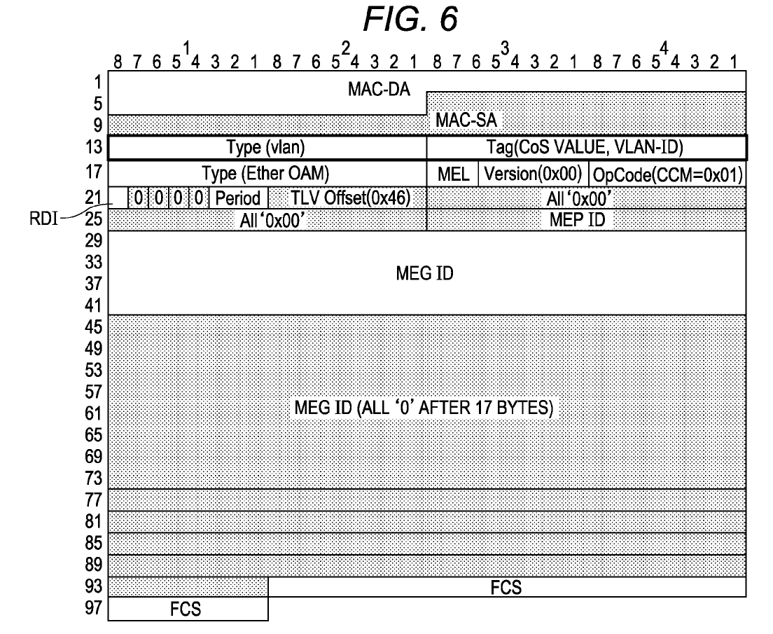

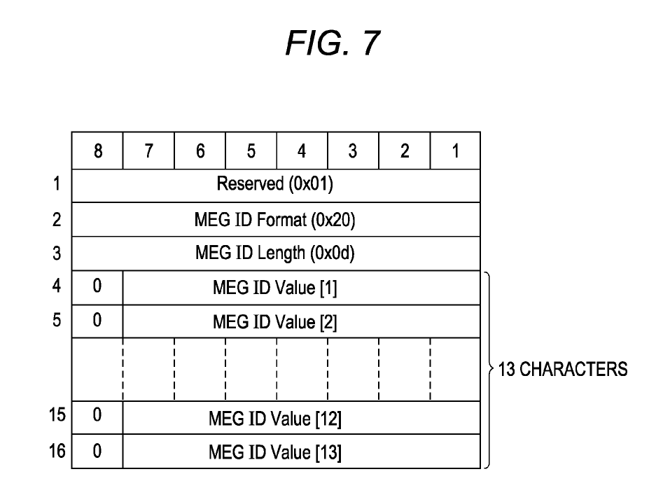

FIGS. 6 and 7 show an example of the format of the CC frame. The CC frame of FIG. 6 includes a destination address (MAC-DA), a source address (MAC-SA), a type (VLAN), a tag (CoS value and VLAN-ID), a type (EtherOAM), MEL (MEG level), a version, an operation code, RDI (Remote Defect Indication), Period, TLV offset, MEP-ID (MEG end point Identifier), and MEG-ID (Maintenance entity Group Identifier). MEG-ID is represented by 13 characters as shown in FIG. 7.

While AIS notices a failure in a downstream direction, the RDI is a signal for noticing a failure in an upstream direction. The MEP represents a management point which generates and terminates an EtherOAM frame. The MEG represents a set of management units ME in EtherOAM. The MEL (MEG level) represents a management level by values of 0 to 7. While the CC frame of a MEL value smaller than the MEG level, previously set in the node device and the EA converter, is discarded, the CC frame of a large MEL value is transparently transferred. The Period (periodical information) is information for confirming whether a period transmitted from its own device and a period transmitted from the counterpart device are matched to each other.

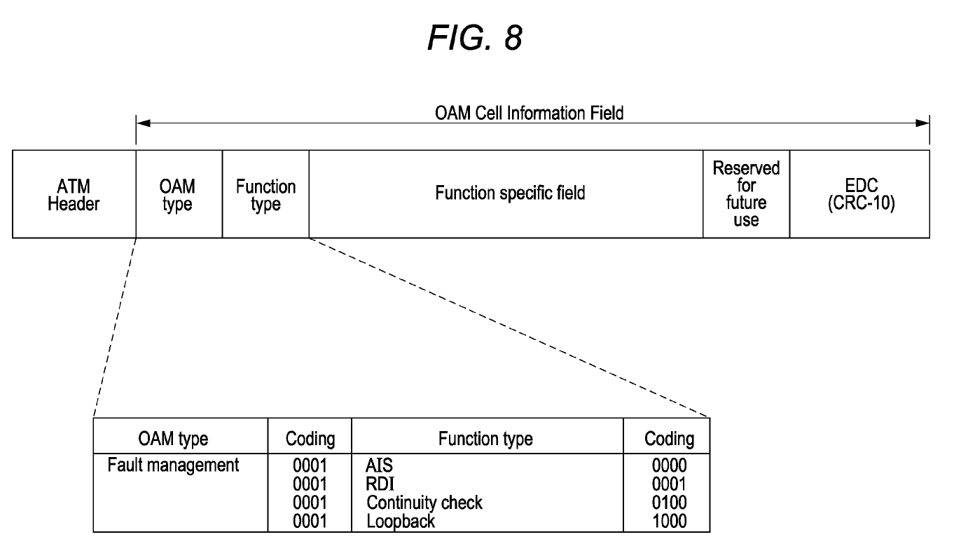

FIG. 8 shows an example of a format of the OAM cell. Subsequent to the ATM header, OAM cell includes an OAM type, a function type, a function specific field, and EDC (CRC-10). When the OAM type is “0001” and the function type is “0100”, the OAM cell is a CC cell for continuity check. The function type is “0000”, the OAM cell is the AIS. The function type is “0001”, the OAM cell is the RDI. The function type is “1000”, the OAM cell is loopback.

<Transmission from ATM Network to LAN Direction>

The cell transmitting/receiving part 29 of FIG. 3 transmits and receives the ATM cell to and from the node device 14 in the ATM network 13. The ATM cell received by the cell transmitting/receiving part 29 is supplied to the cell monitoring part 28.

The cell monitoring part 28 notifies the ATM header of the received ATM cell and the OAM type to a CC generating part 32, and, at the same time, supplies the received ATM cell to the LAN/ATM conversion part 25.

When the ATM cell is a normal cell which is a cell of the user data, the LAN/ATM conversion part 25, as shown in FIG. 5, assembles the AAL5 frame from the ATM cells to extract the LAN frame from the AAL5 frame. The LAN/ATM conversion part 25 referrers the address conversion table 26 by using the VC or the VP of the ATM cell and sets the obtained VLAN-ID to the tag of the LAN frame. The LAN frame from the LAN/ATM conversion part 25 passes through the header processing part 23 and the frame transmitting/receiving part 22 to be transmitted from the physical port 21, corresponding to the VLAN-ID of the LAN frame, to the node device 12 in the LAN 11.

Meanwhile, when the ATM cell is the CC cell, the LAN/ATM conversion part 25 gives the CC cell to the OAM processing part 31. The OAM processing part 31 converts the CC cell into the CC frame of EtherOAM. The OAM processing part 31 then referrers the address conversion table 26 by using the VC or the VP of the CC cell to set the obtained VLAN-ID to the tag of the CC frame, and, thus, to give the VLAN-ID to the LAN/ATM conversion part 25. The CC frame from the LAN/ATM conversion part 25 passes through the header processing part 23 and the frame transmitting/receiving part 22 to be transmitted from the physical port 21, corresponding to the VLAN-ID of the CC frame, to the node device 12 in the LAN 11.

When the LAN frame is the CC frame of EtherOAM, 0×8902 (0×represents hexadecimal display) is default set as the value of the type. In addition, the value of the type may be a specific value (for example, 0×9C00) in the OAM processing part 31. According to this constitution, it can be confirmed in the LAN 11 that the LAN frame is a specific CC frame of EtherOAM bridging the LAN 11 and the ATM network 13.

As described above, the timer 33 times the CC frame received elapsed time from reception of the CC frame for each VLAN-ID and times the cell received elapsed time from reception of the CC cell or the normal cell of the user data for each VC or VP. Further, the timer 33 times the CC frame transmitted elapsed time from transmission of the CC frame for each VLAN-ID and times the cell transmitted elapsed time from transmission of the CC cell or the normal cell of the user data for each VC or VP.

When the cell received elapsed time does not exceeds a predetermined value (for example, several seconds) for each VLAN-ID, and when the CC frame transmitted elapsed time is the CC period (for example, 1 sec.), the CC generating part 32 automatically generates the CC frame of the relevant VLAN-ID to give the CC frame to the LAN/ATM conversion part 25 through the OAM processing part 31, and, thus, to reset the CC frame transmitted elapsed time of the timer 33.

The CC frame from the LAN/ATM conversion part 25 passes through the header processing part 23 and the frame transmitting/receiving part 22 to be transmitted from the physical port 21 corresponding to the VLAN-ID of the CC frame to the node device 12 in the LAN 11.

When the CC frame received elapsed time exceeds a predetermined value (for example, several seconds) for each VLAN-ID, the OAM processing part 31 generates an alarm to notify the alarm to an NMS 17 through a communicating part 34. When the cell received elapsed time exceeds a predetermined value (for example, several seconds) for each VC or VP, the OAM processing part 31 generates an alarm to notify the alarm to the NMS 17 through the communicating part 34.

In FIG. 2, the node device 12 in the LAN 11 generally multicast-transmits the CC frame, and the node device 14 in the ATM network 13 unicast-transmits the CC cell.

Therefore, the CC frame converted from the CC cell in the EA converter 15 may be designated to be multicast-transmitted, or may be designated to be unicast-transmitted to the address of a specified node device in the LAN 11.

In order to designate the multicast-transmission of the CC frame, a predetermined value (for example, 0×0180C200FF00) is set to the destination address (MAC-DA) of the CC frame. In order to designate the unicast-transmission of the CC frame, the address of a specified node device is set to the destination address (MAC-DA) of the CC frame.

In FIG. 3, the communicating part 34 communicates with the NMS 17, whereby setting information (such as MEG level, MEG-ID, MEP-ID, and Period) of the own apparatus received from the NMS 17 is stored in a memory 35. Control information such as an alarm transmitted from the EA converter 15 to the NMS 17 is transmitted to the NMS 17 through the communicating part 34.

<OAM Frame Transmission Processing>

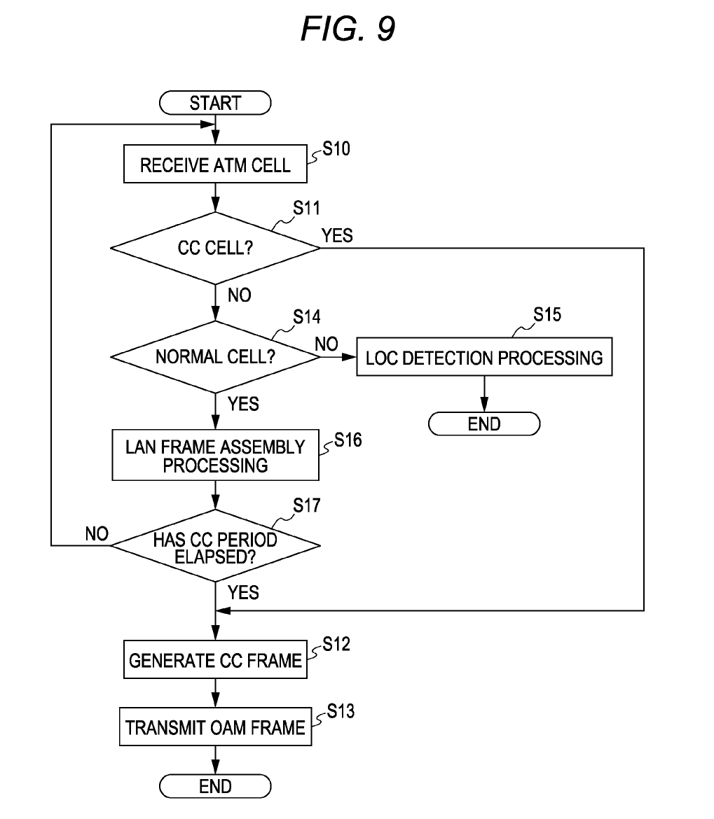

FIG. 9 shows a flow chart of an OAM frame transmission processing performed by the EA converter 15. The processing is performed for each address (VLAN-ID) of the CC frame.

The ATM cell is received in step S10. In step S11, it is determined from the OAM type of the ATM cell whether or not the received ATM cell is the CC cell. When the ATM cell is the CC cell, the processing proceeds to step S12, and the CC frame is generated. The generated CC frame is transmitted to the LAN 11 in step S13, and the OAM frame transmission processing is terminated.

When the received ATM cell is other than the CC cell, it is determined whether or not the ATM cell is a normal cell in step S14. When the ATM cell is not the normal cell, an LOC (Loss of CC) detection processing is performed in step S15, and the OAM frame transmission processing is terminated.

When the received ATM cell is the normal cell, a LAN frame assembly processing is performed in step S16. Thereafter, in step S17, it is determined whether or not a received elapsed time from reception of the ATM cell (user data) or the CC cell has elapsed a predetermined time, that is, the CC period. When the received elapsed time does not elapse the predetermined time, the processing proceeds to step S10.

When the received elapsed time has elapsed the predetermined time, the CC frame is automatically generated in step S12. Thereafter, the generated CC frame is transmitted to the LAN 11 in step S13, and the OAM frame transmission processing is terminated.

<<Monitoring Processing>

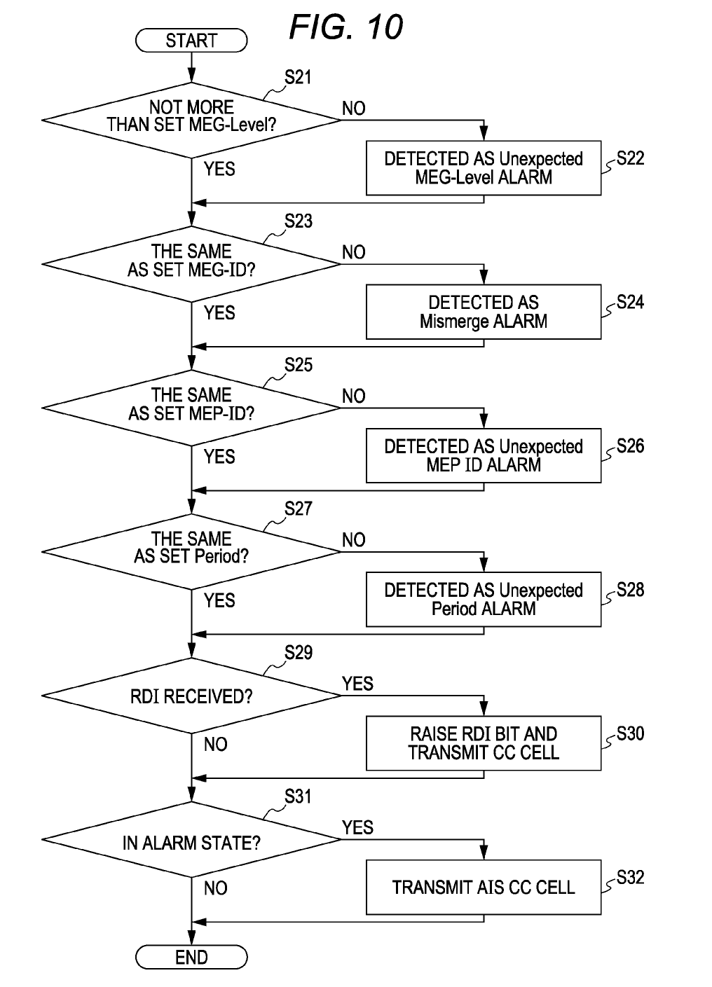

FIG. 10 is a flow chart of a monitoring processing performed by the frame monitoring part 24. The processing is performed when the CC frame or the CC cell is supplied from the LAN/ATM conversion part 25.

In step S21, the OAM processing part 31 determines, from the NMS 17, whether or not the value of the MEL in the CC frame is not more than the MEG level previously set in the memory 35. When the value of the MEL exceeds the MEG level, it is detected as an alarm of the MEG level in step S22 to be transmitted from the communicating part 34 to the NMS 17.

Next, in step S23, it is determined, from the NMS 17, whether or not the value of the MEG-ID in the CC frame is the same as the MEG-ID previously set in the memory 35. When those MEG-IDs are not the same, it is detected as an alarm of MEG-ID mismatching in step S24 to be transmitted from the communicating part 34 to the NMS 17.

Next, in step S25, it is determined, from the NMS 17, whether or not the value of the MEP-ID in the CC frame is the same as the MEP-ID previously set in the memory 35. When those MEP-IDs are not the same, it is detected as an alarm of the MEP-ID in step S26 to be transmitted from the communicating part 34 to the NMS 17.

Next, in step S27, it is determined, from the NMS 17, whether or not a value of the Period (periodical information) in the CC frame is the same as a value of the Period (periodical information) previously set in the memory 35. When the values of the Period are not the same, it is detected as an alarm of Period mismatching in step S26 to be transmitted from the communicating part 34 to the NMS 17.

Next, in step S29, it is determined whether a value of the RDI in the CC frame is 1, that is, whether or not the RDI has been received. When the RDI has been received, in step S30, notification is given to the OAM processing part 31 so that transmission is performed so that the value of the RDI of the CC cell is 1.

Next, in step S31, it is determined whether or not the EA converter 15 is in an alarm state. When the EA converter 15 is in the alarm state, in step S32, notification is given to the OAM processing part 31 so that the CC cell representing the AIS is generated to be transmitted.

When the alarm is transmitted from the communicating part 34 to the NMS 17, the alarm is transmitted by using a Syslog message of TCP (Transmission Control Protocol) or a Trap message of UDP (User Datagram Protocol).

In the above embodiment, the conversion between the VLAN-ID and the VC or the VP is performed by using the address conversion table 26; however, the VC or the VP which is the address of the ATM network 13 is set to the data part of the CC frame transmitted from the LAN 11 to the ATM network 13, and the VC or the VP read from the data part may be set to the ATM header of the CC cell.

Likewise, the VLAN-ID is set to the function specific field of the CC cell transmitted from the LAN 11 to the ATM network 13, and the VLAN-ID read from the function specific field may be set to the tag of the CC frame.

According to the embodiment, the conduction confirmation can be performed across a layer 2 network and an asynchronous network.

<Second Embodiment of EA Converter>

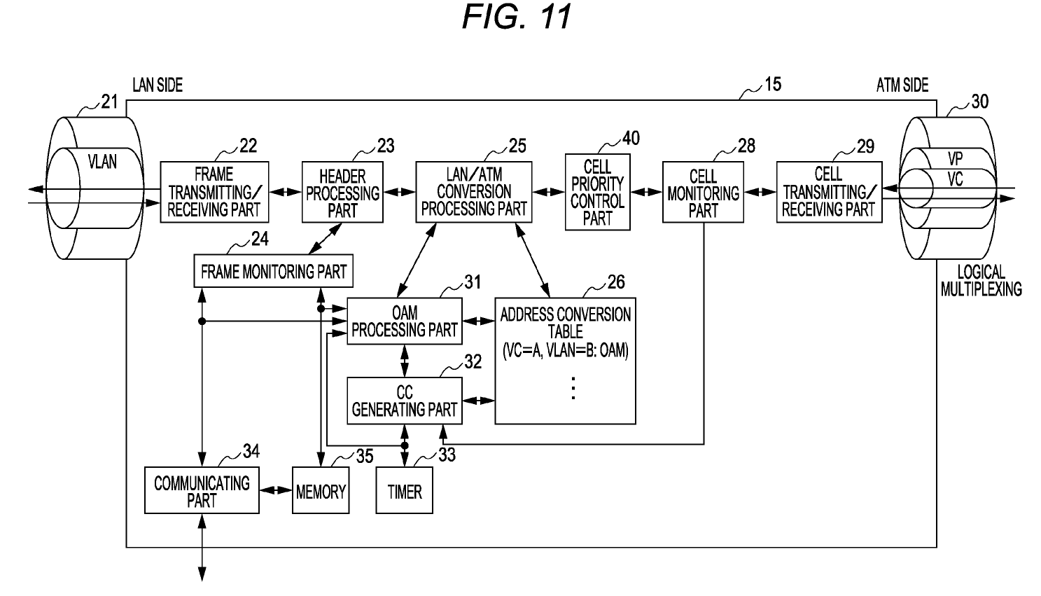

FIG. 11 is a configuration diagram of a second embodiment of the EA converter 15. FIG. 11 is different from FIG. 3 in that a cell priority control part 40 is provided between the LAN/ATM conversion part 25 and the cell monitoring part 28.

The cell priority control part 40 transmits the ATM cell generated from the LAN frame to the ATM network 13 from the cell transmitting/receiving part 29 with a priority according to the value of the class of Service of the monitoring information supplied from the frame monitoring part 24.

The Class of Service of highest priority (CoS=7), for example, is given to all the received CC frames in the frame monitoring part 24, and the monitoring information may be supplied to the cell priority control part 40. According to this constitution, the CC cell converted from the CC frame is transmitted to the ATM network 13 with the highest priority.

Also in the embodiment, the conduction confirmation can be performed across a layer 2 network and an asynchronous network.

<Third Embodiment of EA Converter>

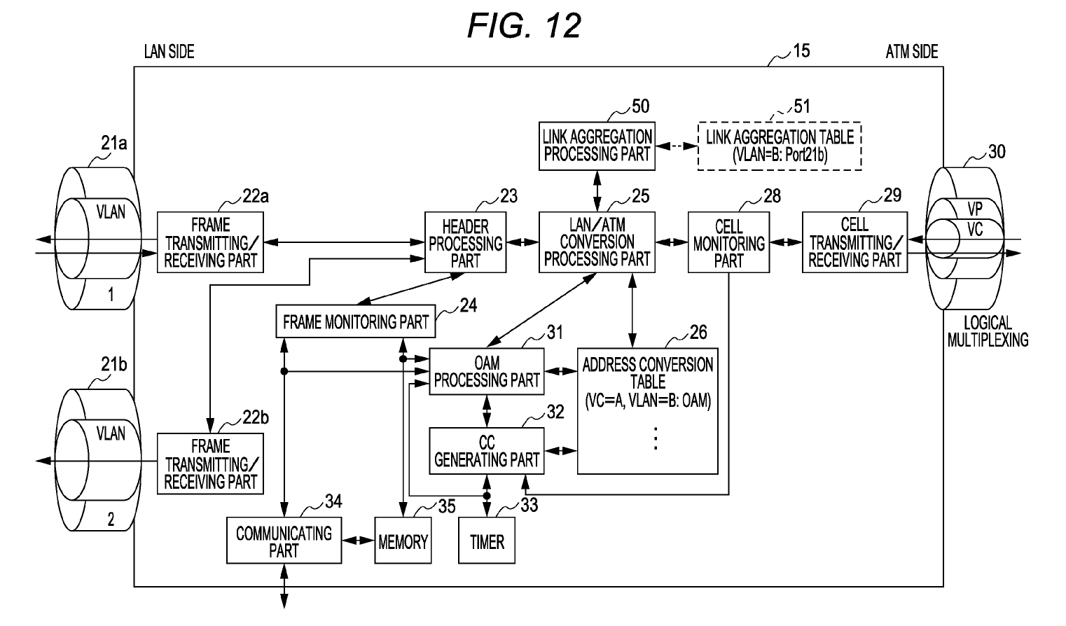

FIG. 12 is a configuration diagram of a third embodiment of the EA converter 15. FIG. 12 and FIG. 3 are different in the following point.

Physical ports 21 a and 21 b of the EA converter 15 are connected to the same or different node devices in the LAN 11 through two transmission paths, and link aggregation (LAG) is set to the physical ports 21a and 21b. A frame transmitting/receiving part 22a transmits and receives the LAN frame to and from the physical port 21a, and a frame transmitting/receiving part 22b transmits and receives the LAN frame to and from the physical port 21b.

A link aggregation processing part 50 is connected to the LAN/ATM conversion part 25. A link aggregation table 51 shown by dashed line may be further connected to the link aggregation processing part 50.

When the LAN frame (including the CC frame) converted from the ATM cell in the LAN/ATM conversion part 25 is transmitted to the LAN 11 through the physical port 21a or 21b to which the link aggregation is set, the link aggregation processing part 50 performs hash calculation of the MAC-DA and the MAC-SA of the LAN frame to thereby determine that the LAN frame (including the CC frame) is transmitted from either the physical port 21a or 21b, and, thus, to notify the determination to the LAN/ATM conversion part 25.

At least one of the physical port 21a and 21b (for example, the physical port 21b) is previously registered on the link aggregation table 51 in accordance with the VLAN-ID instructing the physical port 21a or 21b to which the link aggregation is set. For example when the physical port 21a is set to the active system, and the physical port 21b is set to the standby system, the physical port 21a of the active system is registered on the link aggregation table 51.

Therefore, when the link aggregation table 51 is connected to the link aggregation processing part 50, and when the address (VLAN-ID) of the CC frame instructs the physical port 21a or 21b to which the link aggregation is set, the link aggregation processing part 50 does not perform the hash calculation and refers the link aggregation table 51 with the VLAN-ID to determine the physical port to which the CC frame is transmitted, and, thus, to notify the determination to the LAN/ATM conversion part 25.

<Multipoint Switch>

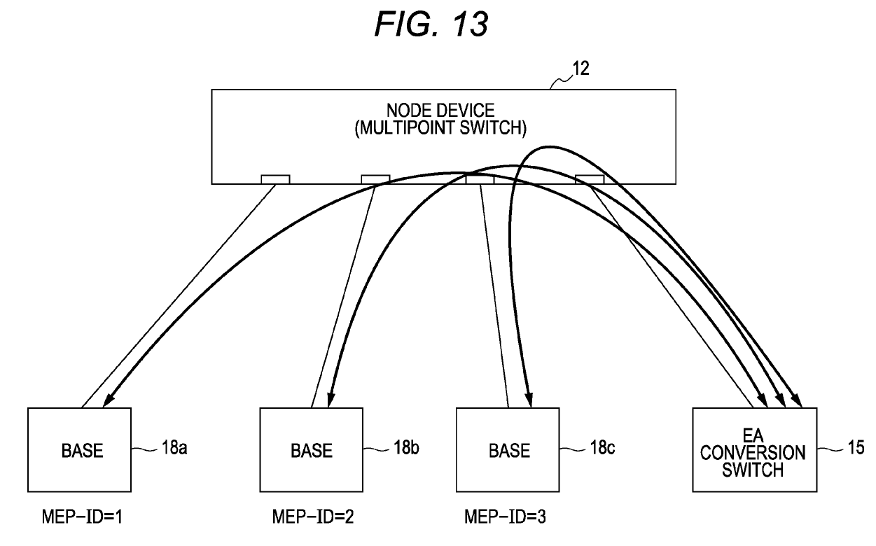

As shown in FIG. 13, such a case is considered that the node device 12 in the LAN 11 is a multipoint switch, and MEP-ID=1, 2, and 3 is set to a memory part 35 of the EA converter 15 with respect to a base 18a of MEP-ID=1, a base 18b of MEP-ID=2, and a base 18c of MEP-ID=3.

In the above case, the CC frames transmitted from the bases 18a, 18b, and 18c are subjected to flooding in the node device 12 to be transmitted to the EA converter 15, and in each transmission of the CC frames, the EA converter 15 converts the CC frames into the CC cells to transmit the CC cells to the ATM network 13.

However, in the above case, the overhead of the EA converter 15 is increased, and therefore, the EA converter 15 has such a constitution that the EA converter 15 transmits one CC cell to the ATM network 13 once received the CC frames from all the bases 18a, 18b, and 18c. According to this constitution, even if the EA converter 15 has received a large number of the CC frames, the EA converter 15 transmits the CC cell for a specified period.

Also according to the embodiment, the conduction confirmation can be performed across a layer 2 network and an asynchronous network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has(have) been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A conversion apparatus, which mutually connects a layer 2 network and an asynchronous network, comprising:
a first converter that converts a check frame received from the layer 2 network into a check cell of the asynchronous network to transmit the check cell to the asynchronous network; and
a second converter that converts the check cell received from the asynchronous network into the check frame of the layer 2 network to transmit the check frame to the layer 2 network.

2. The conversion apparatus according to claim 1, further comprising:
a correspondence table between a virtual network identifier of the layer 2 network and a virtual channel or a virtual path of the asynchronous network,
wherein the first converter converts the check frame received from the layer 2 network into the check cell of the asynchronous network on the basis of the correspondence table, and the second converter converts the check cell received from the asynchronous network into the check frame of the layer 2 network on the basis of the correspondence table.

3. The conversion apparatus according to claim 1, wherein the first converter transmits the check cell to the layer 2 network when an elapsed time from transmission of the check cell or a user data cell to the asynchronous network is a predetermined period.

4. The conversion apparatus according to claim 3, further comprising check frame generation means that, when the check cell or the user data cell from the asynchronous network remains to be received, generates a check frame with a predetermined period to transmit the check frame to the layer 2 network.

5. The conversion apparatus according to claim 4, further comprising alarm generation means that, when reception of the check cell or a cell of user data from the asynchronous network exceeds a predetermined time period larger than the predetermined period, generates an alarm of the check cell.

6. The conversion apparatus according to claim 5, wherein when reception of the check frame from the layer 2 network exceeds a predetermined time period larger than the predetermined period, the alarm generation means generates an alarm of the check frame.

7. The conversion apparatus according to in claim 4, further comprising priority control means that transmits the check cell, output from the first converter, to the asynchronous network with a priority corresponding to priority information included in the check frame received from the layer 2 network.

8. The conversion apparatus according to claim 7, further comprising priority setting means that sets a priority of the check cell, output from the first converter, to a predetermined value.

9. The conversion apparatus according to claim 1, wherein when a plurality of physical ports connected to the layer 2 network is subjected to link aggregation setting, the second converter outputs the converted check frame from a predetermined physical port among the physical ports.

10. The conversion according to claimed in claim 1, wherein the second converter sets and outputs a predetermined address to a destination address of the converted check frame.

11. The conversion apparatus according to claim 1, wherein the second converter sets and outputs multicasts to a destination address of the converted check frame.

12. The conversion apparatus according to claim 5, further comprising communication means that notifies the alarm, generated by the alarm generation means, to a management system.

13. The conversion apparatus according to claim 12, wherein when a MEG level of the check frame received from the layer 2 network exceeds a MEG level previously set to the own apparatus, the alarm generation means generates an alarm of the check frame.

14. The conversion apparatus according to claim 13, wherein when a MEG-ID of the check frame received from the layer 2 network does not match a MEG-ID previously set to the own apparatus, the alarm generation means generates the alarm of the check frame.

15. The conversion apparatus according to claim 14, wherein when a MEP-ID of the check frame received from the layer 2 network does not match a MEP-ID previously set to the own apparatus, the alarm generation means generates the alarm of the check frame.

16. The conversion apparatus according to claim 15, wherein when a Period of the check frame received from the layer 2 network does not match a Period previously set to the own apparatus, the alarm generation means generates the alarm of the check frame.

17. The conversion apparatus according to claim 16, wherein the communication means sets the each MEG level, the MEG-ID, the MEP-ID, and the Period, received from the management system, to the own apparatus.

18. The conversion apparatus according to claim 1, wherein the first converter sets a virtual channel or a virtual path, included in a check frame received from the layer 2 network, to a header of a check cell of an asynchronous network to be converted.

19. The conversion apparatus according to claim 1, wherein the second converter sets a virtual network identifier, included in a check cell received from the asynchronous network, to a tag of a check frame of the layer 2 network.

20. A method of conversion between a layer 2 network and an asynchronous network, comprising:
converting a check frame received from the layer 2 network into a check cell of the asynchronous network;
transmitting the check cell to the asynchronous network;
converting the check cell received from the asynchronous network into the check frame of the layer 2 network; and
transmitting the check frame to the layer 2 network.
